(19) United States
(12) Patent Application Publication
(10) Pub. No.: US 2023/0112258 A1
(43) Pub. Date: Apr. 13, 2023

(54) NOTIFICATION SYSTEM AND ELECTRIC POWER ASSISTED VEHICLE

(71) Applicant: YAMAHA HATSUDOKI KABUSHIKI KAISHA, Iwata-shi (JP)

(72) Inventors: Tomoyuki HIGASHI, Shizuoka (JP); Mitsuharu HASUMI, Shizuoka (JP); Gakuto HOSHIDA, Shizuoka (JP); Masatsugu UDA, Shizuoka (JP); Takahiro ITAGAKI, Shizuoka (JP); Norihiro MOROZUMI, Shizuoka (JP)

(21) Appl. No.: 17/961,893

(22) Filed: Oct. 7, 2022

(30) Foreign Application Priority Data
Oct. 8, 2021 (JP) 2021-166107

(51) Int. Cl. B62J 6/24; B62J 3/14; B62J 50/22; B62J 45/40

(52) U.S. Cl. CPC B62J 6/24; B62J 3/14; B62J 45/40; B62J 50/22

(57) ABSTRACT

A notification system for an electric power assisted vehicle includes two or more notifiers to notify a user that a remaining charge of a battery that supplies power to an electric motor is low, and a controller configured or programmed to control operations of the two or more notifiers. The two or more notifiers include two or more of a display panel to display the remaining battery charge, a lamp to emit light, and a sound component to produce sound. The controller is configured or programmed to compare the remaining battery charge with a predetermined value, and when the remaining battery charge is lower than or equal to the predetermined value, to notify the user that the remaining battery charge is low by a combination of the operations of the two or more notifiers.

### BACKGROUND OF THE INVENTION

### 1. Field of the Invention

The present invention relates to a notification system provided in an electric power assisted vehicle. The present invention also relates to an electric power assisted vehicle equipped with such a notification system.

### 2. Description of the Related Art

Bicycles, which are a daily means of transport, are popular among people regardless of age or gender. Electric power assisted bicycles with an electric motor used to assist the user’s pedaling force have in recent years been becoming widespread (see, for example, Japanese Laid-Open Patent Publication No. 2007-230411).

In the electric power assisted bicycle, the electric motor generates a drive force according to the user’s pedaling force which can reduce the efforts of the user when the user is traveling on a hill or carrying a payload. The electric motor uses power supplied from a battery mounted on the vehicle to generate the drive force.

As power is supplied from the battery to the electric motor, the remaining battery charge decreases gradually. The battery can be repeatedly used by being recharged when the remaining charge is low. If the user does not recharge the battery, then when the remaining battery charge decreases to zero or near zero levels, the electric motor can no longer generate assistance power.

### SUMMARY OF THE INVENTION

It is desirable that when the remaining battery charge in the electric power assisted vehicle is low, the user should be notified of such a state and thus prompted to recharge the battery.

A notification system for an electric power assisted vehicle according to a preferred embodiment of the present includes two or more notifiers to notify a user that the remaining charge of a battery that supplies power to an electric motor is low, and a controller configured or programmed to control operations of the two or more notifiers. The two or more notifiers include two or more of a display panel to display the remaining battery charge, a lamp to emit light, and a sound component to produce sound. The controller is configured or programmed to compare the remaining battery charge with a predetermined value. When the remaining battery charge is lower than or equal to the predetermined value, the controller is configured or programmed to notify the user that the remaining battery charge is low by a combination of the operations of the two or more notifiers.

The display on the display panel alone may not be enough for the user to actually become aware of the notification. The use of a single notifier, i.e., light or sound alone, may not be enough for the user to recognize what kind of notification is provided. According to a preferred embodiment of the present invention, a combination of the operations of the two or more notifiers enables the user to easily and reliably become aware of the notification, and easily recognize that the remaining battery charge is low.

In a preferred embodiment of the present invention, the two or more notifiers may include the display panel. When the remaining battery charge is higher than the predetermined value, the controller is configured or programmed to cause the display panel to display the remaining battery charge, and may cause the other ones of the two or more notifiers not to operate.

The user is able to recognize the remaining battery charge by seeing the display panel.

In a preferred embodiment of the present invention, the two or more notifiers may include the display panel and the lamp. When the remaining battery charge is lower than or equal to the predetermined value, the controller may cause the display panel and the lamp to notify the user that the remaining battery charge is low by a combination of a remaining battery charge display on the display panel and light emitted by the lamp.

The combination of the display on the display panel and the light emitted by the lamp enables the user to easily notice the notification, and easily recognize that the notification is about a low remaining battery charge.

In a preferred embodiment of the present invention, the two or more notifiers may include the display panel and the sound component. When the remaining battery charge is lower than or equal to the predetermined value, the controller may cause the display panel and the sound component to notify the user that the remaining battery charge is low by a combination of a remaining battery charge display on the display panel and sound produced by the sound component.

The combination of the display on the display panel and the sound produced by the sound component enables the user to easily notice the notification, and easily recognize that the notification is about a low remaining battery charge.

In a preferred embodiment of the present invention, the two or more notifiers may include the display panel, the lamp, and the sound component. When the remaining battery charge is lower than or equal to the predetermined value, the controller may cause the display panel, the lamp, and the sound component to notify the user that the remaining battery charge is low by a combination of a remaining battery charge display on the display panel, light emitted by the lamp, and sound produced by the sound component.

The combination of the display on the display panel, the light emitted by the lamp, and the sound produced by the sound component enables the user to easily notice the notification, and easily recognize that the notification is about a low remaining battery charge.

In a preferred embodiment of the present invention, when a notification to the user is performed by a combination of the operations of the two or more notifiers, the controller may be configured or programmed to synchronize the operations of the two or more notifiers with each other.

The synchronization of the operations of the two or more notifiers enables the user to easily recognize that the operations of the two or more notifiers are associated with each other.

In a preferred embodiment of the present invention, the controller may be configured or programmed to provide different notification operations by different combinations of the operations of the two or more notifiers, the notification operations differing between when the remaining battery charge is within a first predetermined range and when the remaining battery charge is within a second predetermined range that is lower than the first predetermined range.

The different notification operations depending on the remaining battery charge enables the user to easily recognize how low the remaining battery charge is.

In a preferred embodiment of the present invention, the two or more notifiers may include the display panel, the lamp, and the sound component. When the remaining battery charge is within the first predetermined range, the controller may be configured or programmed to notify the user that the remaining battery charge is within the first predetermined range by a remaining battery charge display on the display panel and a combination of one of light emitted by the lamp and sound produced by the sound component. When the remaining battery charge is within the second predetermined range, the controller may be configured or programmed to notify the user that the remaining battery charge is within the second predetermined range by a combination of the remaining battery charge display on the display panel and the other of the light emitted by the lamp and the sound produced by the sound component.

By using different notifiers, depending on the amount of a decrease in the remaining battery charge, the user is able to more easily recognize the amount of a decrease in the remaining battery charge.

In a preferred embodiment of the present invention, the two or more notifiers may include the display panel, the lamp, and the sound component. When the remaining battery charge is within the first predetermined range, the controller may be configured or programmed to notify the user that the remaining battery charge is within the first predetermined range by a remaining battery charge display on the display panel and a combination of one of light emitted by the lamp and sound produced by the sound component. When the remaining battery charge is within the second predetermined range, the controller may notify the user that the remaining battery charge is within the second predetermined range by a combination of the light emitted by the lamp, the sound produced by the sound component, and the remaining battery charge display on the display panel.

By increasing the number of notifiers that actually perform the notification with a decrease in the remaining battery charge, the user is able to more easily recognize the amount of a decrease in the remaining battery charge.

In a preferred embodiment of the present invention, when the remaining battery charge is lower than or equal to the predetermined value, and if the user performs an operation to turn off a power supply of the electric power assisted vehicle, the controller may be configured or programmed to cause the two or more notifiers to notify the user that the remaining battery charge is low by a combination of the operations of the two or more notifiers.

Thus, when it is time to turn off the power supply of the electric power assisted vehicle (e.g., when the user returns home), the user is notified, and therefore, is prevented from forgetting to recharge the battery.

In a preferred embodiment of the present invention, the two or more notifiers may include the sound component, and the notification system may further include a user interface to receive the user’s operation of prohibiting the sound component to produce sound. Even if the sound component is prohibited to produce sound, and when the remaining battery charge is lower than or equal to the predetermined value, and the user performs an operation to turn the power supply off, the controller may be configured or programmed to cause the sound component to produce sound.

Thus, when it is time to turn the power supply off, notification by sound is performed irrespective of whether the sound production is prohibited. Therefore, the user is prevented from forgetting to recharge the battery.

In a preferred embodiment of the present invention, when the remaining battery charge is lower than or equal to the predetermined value, and if the user performs an operation to lock the electric power assisted vehicle, the controller may be configured or programmed to cause the two or more notifiers to notify the user that the remaining battery charge is low by a combination of the operations of the two or more notifiers.

Thus, when it is time to lock the electric power assisted vehicle (e.g., when the user returns home), the user is notified, and therefore, is prevented from forgetting to recharge the battery.

In a preferred embodiment of the present invention, when the remaining battery charge is lower than or equal to the predetermined value, and if the electric power assisted vehicle is at rest, the controller may be configured or programmed to cause the two or more notifiers to notify the user that the remaining battery charge is low by a combination of the operations of the two or more notifiers.

Thus, when the vehicle is at rest, the user is notified, and therefore, easily notices the notification.

In a preferred embodiment of the present invention, when the user performs an operation to turn on a power supply of the electric power assisted vehicle, and if the remaining battery charge is lower than or equal to the predetermined value, the controller may be configured or programmed to cause the two or more notifiers to notify the user that the remaining battery charge is low by a combination of the operations of the two or more notifiers.

Thus, when the power supply of the electric power assisted vehicle is turned on, the user is notified, and therefore, is prompted to travel using reduced power.

In a preferred embodiment of the present invention, the two or more notifiers may include the display panel and the lamp. The lamp may be disposed adjacent or near to a portion of the display panel in which the remaining battery charge is displayed.

The user, when noticing the light emitted by the lamp, is more likely to pay attention to the remaining battery charge display on the display panel, and therefore, easily recognizes that the remaining battery charge is low.

In a preferred embodiment of the present invention, the display panel may display an indicator to indicate the remaining battery charge.

Thus, the remaining battery charge is displayed by the indicator. This enables the user to intuitively recognize the remaining battery charge.

An electric power assisted vehicle according to a preferred embodiment of the present invention includes the above notification system.

The electric power assisted vehicle enables the user to easily recognize that the remaining battery charge is low.

According to a preferred embodiment of the present invention, when the remaining battery charge is lower than or equal to a predetermined value, the user is notified that the remaining battery charge is low by a combination of two or more notifiers of a display panel, a lamp, and a sound component.

The display on the display panel alone may not be enough for the user to actually become aware of the notification. The use of a single notifier, i.e., light or sound alone, may not be enough for the user to recognize what kind of notification is provided. According to a preferred embodiment of the present invention, a combination of the operations of the two or more notifiers enables the user to easily notice the notification, and easily recognize that the remaining battery charge is low.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a side view illustrating an electric power assisted vehicle 1 according to a preferred embodiment of the present invention.

FIG. 2 is a top view of an operation board 5 according to a preferred embodiment of the present invention.

FIG. 3 is a hardware diagram of an operation board 5 according to a preferred embodiment of the present invention.

FIG. 4 is a flowchart illustrating a process of notifying a user that the remaining charge of a battery is low according to a preferred embodiment of the present invention.

FIG. 5 is a diagram illustrating an example of an operation of notifying a user according to a preferred embodiment of the present invention.

FIG. 6 is a flowchart illustrating a process of changing ways of notification, depending on the remaining charge of a battery, according to a preferred embodiment of the present invention.

FIG. 7 is a diagram illustrating an example of an operation for a second notification according to a preferred embodiment of the present invention.

FIG. 8 is a flowchart illustrating a notification process that is performed when the power supply of an electric power assisted bicycle 1 is turned off according to a preferred embodiment of the present invention.

FIG. 9 is a flowchart illustrating a notification process that is performed when a user locks an electric power assisted bicycle 1 according to a preferred embodiment of the present invention.

FIG. 10 is a flowchart illustrating a notification process that is performed when an electric power assisted bicycle 1 is at rest according to a preferred embodiment of the present invention.

FIG. 11 is a diagram illustrating a front portion of an electric power assisted bicycle 1 at which a child bicycle seat 90 is provided on a handlebar 4 according to a preferred embodiment of the present invention.

FIG. 12 is a perspective view of an operation board according to a preferred embodiment of the present invention.

### DETAILED DESCRIPTION OF THE PREFERRED EMBODIMENTS

Notification systems and electric power assisted vehicles including the notification systems according to preferred embodiments of the present invention will be described below with reference to the accompanying drawings. In the description of the preferred embodiments, like parts are indicated by like reference characters and will not be redundantly described. In the preferred embodiments of the present invention, the terms “front” and “forward,” “rear” and “rearward,” “left” and “leftward,” “right” and “rightward,” “upper” and “upward,” and “lower” and “downward” each have a meaning that is defined in relation to a user who is sitting on the seat (saddle) of an electric power assisted vehicle and facing the handlebar. The preferred embodiments below are merely for illustrative purposes, and the present invention is not limited to the preferred embodiments below.

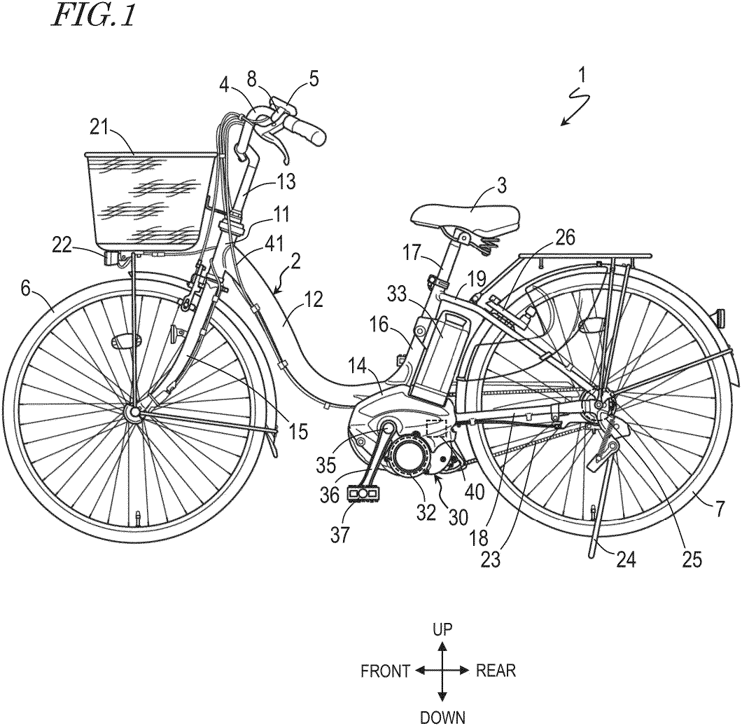

FIG. 1 is a side view illustrating an electric power assisted vehicle 1 according to a preferred embodiment of the present invention. The electric power assisted vehicle 1 is, for example, an electric power assisted bicycle. The present invention is not limited to this. An example in which the electric power assisted vehicle 1 is an electric power assisted bicycle will be described below.

The electric power assisted bicycle 1 includes a body frame 2 that extends in a longitudinal direction (forward and rearward). The body frame 2 includes a head pipe 11, a down tube 12, a bracket 14, a chain stay 18, a seat tube 16, and a seat stay 19. The head pipe 11 is disposed at a front end of the body frame 2. A handlebar stem 13 is rotatably inserted in the head pipe 11. A handlebar 4 is fixed at an upper end portion of the handlebar stem 13. A front fork 15 is fixed at a lower end portion of the handlebar stem 13. A lower end portion of the front fork 15 supports a front wheel 6, which is a steered wheel. A front-mounted basket 21 is provided in front of the head pipe 11. A headlight 22 is provided below the front-mounted basket 21.

The down tube 12 extends diagonally downward and rearward from the head pipe 11. The seat tube 16 extends upward from a rear end portion of the down tube 12. The chain stay 18 extends rearward from a lower end portion of the seat tube 16. The bracket 14 connects a rear end portion of the down tube 12, a lower end portion of the seat tube 16, and a front end portion of the chain stay 18 together. The seat tube 16 is inserted in a seat post 17. A saddle 3 that a user sits on is provided at an upper end portion of the seat post 17.

A rear portion of the chain stay 18 rotatably supports a rear wheel 7, which is a drive wheel. A speed sensor 25 that detects the rotation of the rear wheel 7 is provided at a rear portion of the chain stay 18. A kickstand 24 that supports the bicycle in an upright position when the bicycle is parked is provided at a rear portion of the chain stay 18. The seat stay 19 extends diagonally downward and rearward from an upper portion of the seat tube 16. A lower end portion of the seat stay 19 is connected to a rear portion of the chain stay 18. A lock 26 that prevents the rear wheel 7 from rotating when the rear wheel 7 is locked is provided on the seat stay 19.

A drive unit 30 is provided on the bracket 14, which is located near a vehicle center portion of the body frame 2. The drive unit 30 includes an electric motor 32, a crank shaft 35, and a motor control unit (MCU) 40. A battery 33 that supplies power to the electric motor 32 and the like is mounted on the bracket 14. The battery 33 may be supported by the seat tube 16. The battery 33 may be removably attached to the electric power assisted bicycle 1.

The crank shaft 35 is supported by the drive unit 30, penetrating through the drive unit 30 in a transverse direction (leftward and rightward). A crank arm 36 is provided at either end portion of the crank shaft 35. A pedal 37 is rotatably provided at a tip end of each crank arm 36.

The MCU 40 controls the operation of the electric motor 32, and also controls the operation of each element of the electric power assisted bicycle 1. The MCU 40 includes a semiconductor integrated circuit such as a processor, and a motor drive circuit. The rotation of the crank shaft 35 generated by the user pushing the pedals 37 by their feet is transmitted to the rear wheel 7 through a chain 23. The MCU 40 controls the electric motor 32 so that the electric motor 32 generates a drive assistance power according to the rotation power of the crank shaft 35. The assistance power generated by the electric motor 32 is transmitted to the rear wheel 7 through the chain 23. A belt, shaft, or the like may be used instead of the chain 23.

The handlebar 4 is provided with an operation board 5. The operation board 5 is attached to the handlebar 4 by, for example, a clamp 8. The user is able to perform various operations such as setting the magnitude of the assistance power of the electric motor 32 by operating the operation board 5 with their finger. The operation board 5 and the MCU 40 may exchange signals through a wire 41.

Next, the operation board 5 will be described in detail.

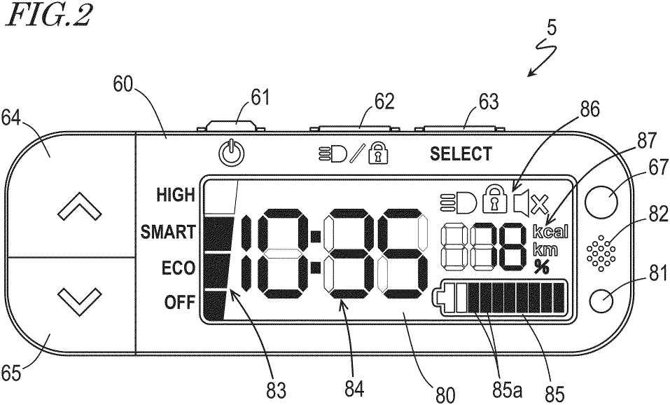

FIG. 2 is a top view of the operation board 5. The operation board 5 includes a housing 60, a plurality of switches 61, 62, 63, 64, and 65 that receive the user’s operation, an optical sensor 67, and a display panel 80. Specifically, the plurality of switches include a power supply switch 61, a headlight switch 62, a select switch 63, and assistance power setting switches 64 and 65. In a preferred embodiment of the present invention, these switches are push-button switches that are pressed and operated by the user’s finger.

The power supply switch 61 is used to turn on and off the power supply of the electric power assisted bicycle 1. When the power supply of the electric power assisted bicycle 1 is on, the drive unit 30 operates, and when the power supply is off, the drive unit 30 does not operate. When the power supply is off, then if the user presses down the power supply switch 61, the power supply is turned on. When the power supply is on, then if the user presses down the power supply switch 61, the power supply is turned off.

The display panel 80 displays various kinds of information according to the user’s operation on the operation board 5. The display panel 80 is, for example, a liquid crystal panel. In a preferred embodiment of the present invention, the display panel 80 displays text, symbols, icons, and the like in a segment format. Alternatively, the display panel 80 displays text, symbols, icons, and the like in a dot-matrix format. Besides liquid crystal panels, the display panel 80 may be another display panel such as an organic light-emitting diode (OLED) panel or an electronic paper panel.

The operation board 5 has a clock function. Time information 84 is displayed in a central display area of the display panel 80. In the example illustrated in FIG. 2, time “10:35” is being displayed. In a preferred embodiment of the present invention, a processor included in the operation board 5 calculates time, and causes the display panel 80 to display the calculated time.

The select switch 63 is used to change display contents on the display panel 80. In a preferred embodiment of the present invention, selected information 87 selected by the user operating the select switch 63 is displayed in a central display area on the right side of the display panel 80. The selected information 87 may include, for example, the user’s consumed calories, a remaining distance that power assistance can still be provided (remaining assistance distance), and the remaining charge of the battery 33. Each time the user presses down the select switch 63, the display on the display panel 80 is switched between the consumed calories, the remaining assistance distance, and the remaining battery charge, sequentially in the stated order. In the example of FIG. 2, “78%” is displayed as the remaining battery charge. The words “kcal” and “km” represent the units of the consumed calories and the remaining assistance distance, respectively.

In a preferred embodiment of the present invention, a distance between the select switch 63 and a position where the selected information 87 is displayed is shorter than the distances between the other switches and the position where the selected information 87 is displayed. The shorter distance between the select switch 63 and the position where the selected information 87 is displayed enables the user to easily recognize the function of the select switch 63, resulting in an intuitive operation.

The assistance power setting switches 64 and 65 are used to set the assistance power of the electric motor. In a preferred embodiment of the present invention, a plurality of assist modes are able to be set for the electric power assisted bicycle 1. The plurality of assist modes include, for example, a no-assist mode, eco mode, smart mode, and high mode, which are stated in ascending order of magnitude of assistance power to the user’s pedaling force. In the no-assist mode, the electric motor 32 does not generate assistance power. When the user presses down the assistance power setting switch 64, the assist mode is changed from an assist mode in which a relatively low assistance power is provided to the user’s pedaling force to another assist mode in which a relatively high assistance power is provided to the user’s pedaling force. When the user presses down the assistance power setting switch 65, the assist mode is changed from an assist mode in which a relatively high assistance power is provided to the user’s pedaling force to another assist mode in which a relatively low assistance power is provided to the user’s pedaling force. In a preferred embodiment of the present invention, assist mode information 83 indicating an assist mode selected by the user is displayed in a display area on the left side of the display panel 80. In the example of FIG. 2, a display pattern including a plurality of segments is changed according to the selected assist mode to indicate the selected assist mode.

In the above example, there are four assist modes. The number of assist modes may be at most three or at least five. For example, there may be a mode in which an assistance power higher than that in the high mode is generated, or there may be a plurality of different eco modes.

The headlight switch 62 is used to turn on and off the headlight 22 (FIG. 1). When the user presses down the headlight switch 62 to turn the headlight 22 on, the headlight 22 emits light and thus illuminates a path ahead of the electric power assisted bicycle 1. In a preferred embodiment of the present invention, setting information 86 indicating settings of the electric power assisted bicycle 1 is displayed in an upper right display area of the display panel 80. When the headlight 22 is on, an icon representing the on-state of the headlight 22 is displayed as the setting information 86.

In a preferred embodiment of the present invention, by pressing and holding the headlight switch 62, the operation of the power supply switch 61 is locked. Pressing and holding a switch is the user’s operation of continuing to press down the switch using their finger, and releasing the finger from the switch after a period of time longer than a reference time (e.g., 3 seconds) has passed. In the locked state in which the operation of the power supply switch 61 is locked, the power supply is not turned off even when the user presses down the power supply switch 61. During the locked state, an icon indicating that the operation of the power supply switch 61 is locked is displayed as the setting information 86. When the headlight switch 62 is pressed and held during the locked state, the locked state of the power supply switch 61 is removed.

The optical sensor 67 receives ambient light around the electric power assisted bicycle 1. The optical sensor 67 outputs a signal according to the received light. The headlight 22 is turned on and off according to the output signal of the optical sensor 67. This enables the headlight 22 to be automatically turned on and off, depending on the amount of ambient light around the electric power assisted bicycle 1. The optical sensor 67 is, for example, but not limited to, an illuminance sensor.

The display panel 80 also displays remaining battery charge information 85 indicating the remaining charge of the battery 33. In a preferred embodiment of the present invention, the display panel 80 displays an indicator to indicate the remaining charge of the battery 33 as the remaining battery charge information 85. In the example of FIG. 2, the indicator 85 includes a plurality of segments 85a. The number of segments 85a that are on (i.e., lit) is changed according to the remaining battery charge. The user is able to intuitively recognize the remaining charge of the battery 33 by seeing the indicator 85.

The operation board 5 further includes notifiers 81 and 82 that notify the user of a low remaining battery charge when the remaining charge of the battery 33 is low.

The notifier 81 is a lamp that emits light when the remaining charge of the battery 33 is low. When the lamp 81 emits light, the user recognizes that the remaining charge of the battery 33 is low. The lamp 81 is, for example, but not limited to, a light-emitting diode (LED).

The notifier 82 is a sound component that produces sound when the remaining charge of the battery 33 is low. When the sound component 82 produces sound, the user recognizes that the remaining charge of the battery 33 is low. The sound component 82 is, for example, but not limited to, a buzzer or loudspeaker.

The display panel 80, which displays the remaining battery charge, is also a notifier that notifies the user of a low remaining battery charge when the remaining charge of the battery 33 is low.

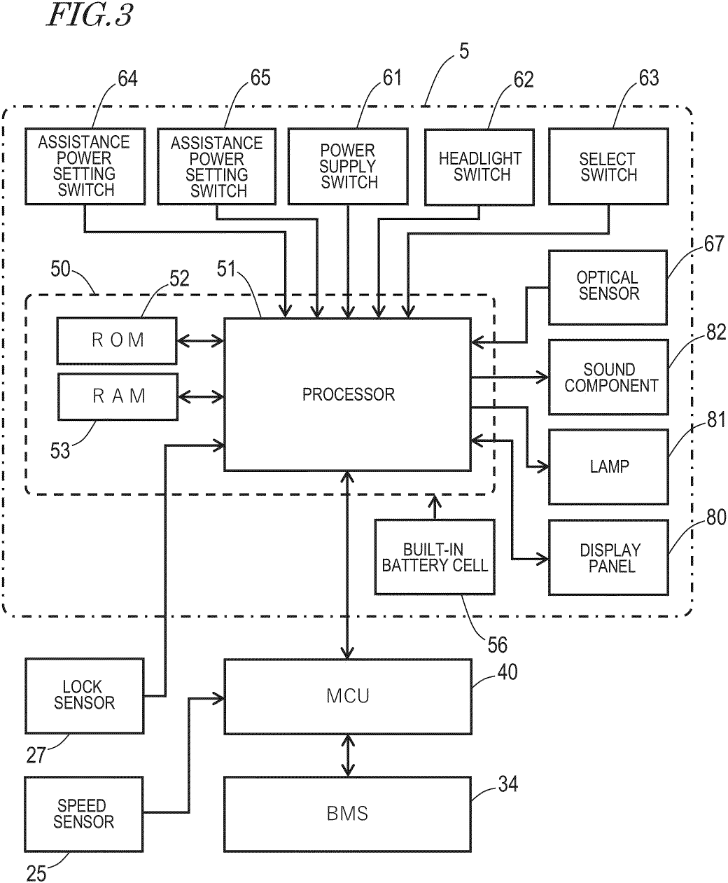

FIG. 3 is a hardware diagram of the operation board 5. The operation board 5 further includes a control device 50 and a built-in battery cell 56.

The control device 50 detects when each switch of the operation board 5 is pressed down, and controls the operations of the display panel 80, the lamp 81, and the sound component 82. The control device 50 includes a processor 51, and storage media such as a read only memory (ROM) 52 and a random access memory (RAM) 53. The processor 51 may be, for example, a semiconductor integrated circuit. The processor 51 may be operated by power supplied from the built-in battery cell 56. The processor 51 may also be operated by power supplied from the battery 33 when the power supply of the electric power assisted bicycle 1 is on. The built-in battery cell 56 may be, for example, a primary cell, button cell, or the like. Alternatively, the built-in battery cell 56 may be a rechargeable secondary cell.

The ROM 52 stores a computer program (or firmware) that causes the processor 51 to execute processes. The processor 51 reads and loads the computer program from the ROM 52 to the RAM 53, and executes various processes. The RAM 53 and the ROM 52 may be integrated in the processor 51.

The processor 51 detects when each switch is pressed down. For example, when the user starts pressing down a switch, the processor 51 detects at least a predetermined voltage value and/or current value. When the user ends pressing down the switch, the processor 51 detects when the voltage value and/or current value detected so far becomes zero, for example. The processor 51 is able to detect, in parallel, when a plurality of switches are pressed down simultaneously.

The processor 51 changes the display contents of the display panel 80 according to a pressed switch of the operation board 5. The processor 51 transmits a signal corresponding to a pressed switch of the operation board 5 to the MCU 40. For example, the processor 51 transmits a signal indicating a selected assist mode to the MCU 40. The MCU 40, when receiving the signal, causes the electric motor 32 to generate an assistance power according to the selected assist mode.

A battery management system (BMS) 34 is mounted on the battery 33. The BMS 12 controls various operations such as charging/discharging of the battery 33, and monitors various states of the battery 33. The BMS 12 monitors the voltage, current, temperature, state of charge (SoC), and the like of the battery 33. The MCU 40 and the BMS 12 exchange necessary information with each other. The MCU 40 receives, from the BMS 12, battery information indicating the voltage, current, temperature, SoC, and the like of the battery 33.

The MCU 40 outputs SoC information indicating the SoC of the battery 33 to the operation board 5. The processor 51 controls the display on the display panel 80 related to the remaining battery charge calculated based on the SoC information. When the remaining charge of the battery 33 is low, the processor 51 causes the notifiers 80, 81, and 82 to perform an operation of notifying the user that the remaining battery charge is low.

The operation board 5 is an example of a notification system that notifies the user of a low remaining battery charge when the remaining charge of the battery 33 is low.

Next, an operation of notifying the user of a low remaining battery charge when the remaining charge of the battery 33 is low will be described.

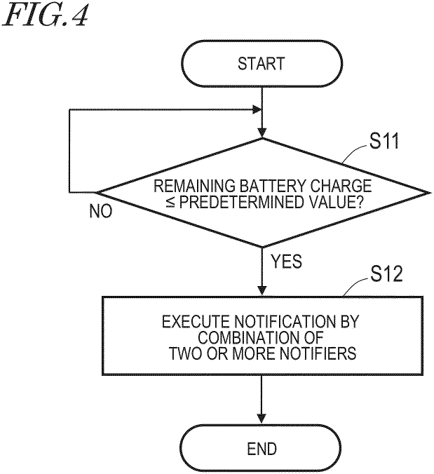

FIG. 4 is a flowchart illustrating a process of notifying the user of a low remaining battery charge when the remaining charge of the battery 33 is low. The processor 51 regularly calculates the remaining charge of the battery 33 from the SoC or the like of the battery 33. In a preferred embodiment of the present invention, the remaining battery charge is 100% when the battery 33 is fully charged, and 0% when the battery 33 is fully discharged.

In step S11, the processor 51 compares the remaining battery charge with a predetermined value. The predetermined value is any appropriate value, and is, for example, but not limited to, at most 30%. In a preferred embodiment of the present invention, as an example, the predetermined value is 20%.

When the remaining battery charge is higher than the predetermined value, the processor 51 causes the lamp 81 and the sound component 82 not to perform a notification operation. The display panel 80 displays the indicator 85 corresponding to the current remaining battery charge.

When the remaining battery charge is lower than or equal to the predetermined value, the processor 51 notifies the user that the remaining battery charge is low by a combination of the operations of two or more of the notifiers, i.e., the display panel 80, the lamp 81, and the sound component 82 (step S12) .

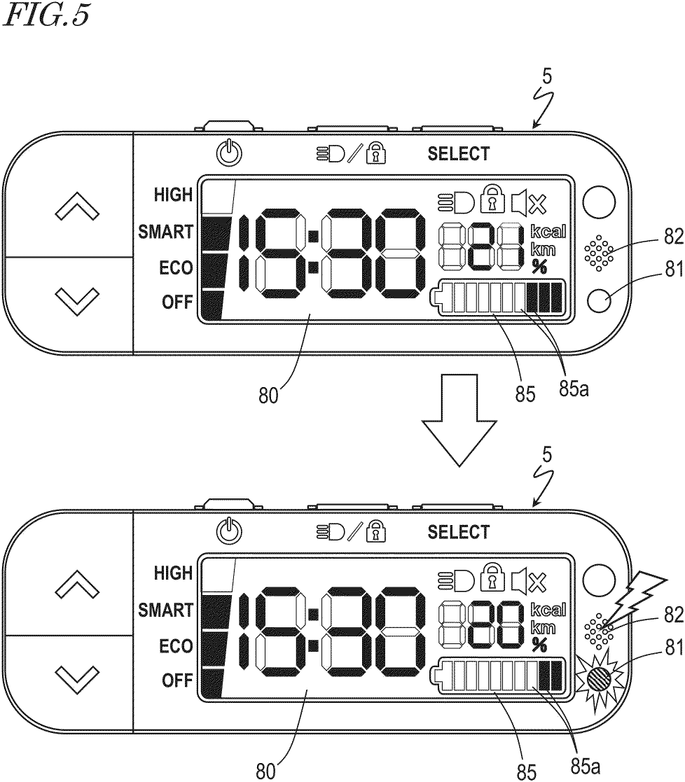

FIG. 5 is a diagram illustrating an example of an operation of notifying the user. The upper diagram of FIG. 5 illustrates a state of the operation board 5 that occurs when the remaining battery charge is higher than the predetermined value. The lower diagram of FIG. 5 illustrates a state of the operation board 5 that occurs when the remaining battery charge is lower than or equal to the predetermined value.

When the remaining battery charge is changed from a value higher than the predetermined value to a value lower than or equal to the predetermined value, the processor 51 decreases the number of on-state (lit) segments 85a in the indicator 85 by one. In parallel with this, the processor 51 causes the lamp 81 to emit light, and causes the sound component 82 to produce sound. For example, the lamp 81 is turned on, and the sound component 82 is caused to produce high-pitched beeps.

When an attempt is made to notify the user that the remaining battery charge is low, the display on the display panel 80 alone may not be enough for the user to actually become aware of the notification. In addition, the use of a single notifier, i.e., light or sound alone, may not be enough for the user to recognize what kind of notification is provided. In a preferred embodiment of the present invention, the combination of the remaining battery charge display on the display panel 80, the light emitted by the lamp 81, and the sound produced by the sound component 82 enables the user to easily and reliably become aware of the notification, and easily recognize that the notification is about a low remaining battery charge.

When the remaining battery charge is lower than or equal to the predetermined value, the processor 51 may cause on-state segments 85a of the indicator 85 to blink. This enables the user to easily recognize that the notification is about a low remaining battery charge.

In a preferred embodiment of the present invention, the lamp 81 is adjacent or close to a portion of the display panel 80 where the remaining battery charge is displayed. For example, a distance between the lamp 81 and the display position of the remaining battery charge (the display position of the indicator 85) is shorter than distances between the lamp 81 and the display positions of information other than the remaining battery charge. As a result, the user, when noticing the light emitted by the lamp 81, is more likely to pay attention to the remaining battery charge display on the display panel 80, and therefore, easily recognize that the remaining battery charge is low.

The sound component 82 is disposed at a position that enables the produced sound to be heard by the user, for example, a side portion or bottom portion of the operation board 5.

In the foregoing, the processor 51 notifies the user by a combination of the operations of the display panel 80, the lamp 81, and the sound component 82. Alternatively, the operations of two of the three notifiers may be combined to notify the user.

For example, the processor 51 may notify the user by a combination of the operations of two notifiers, e.g., the display panel 80 and the lamp 81. In that case, the operation board 5 may not include the sound component 82.

For example, the processor 51 may notify the user by a combination of the operations of two notifiers, e.g., the display panel 80 and the sound component 82. In that case, the operation board 5 may not include the lamp 81.

For example, in the case in which the display panel 80 does not display the remaining battery charge, or the operation board 5 does not include the display panel 80, the processor 51 may notify the user by a combination of the operations of two notifiers, i.e., the lamp 81 and the sound component 82.

By notifying the user by a combination of the operations of two or more notifiers, the user is able to more easily notice the notification, and more easily recognize that the remaining battery charge is low.

In the case in which the user is notified by a combination of the operations of two or more notifiers, the operations of the two or more notifiers may be started with the same timing. For example, the operations of the lamp 81 and/or the sound component 82 may be synchronized with an operation of changing the display of the indicator 85. When the operations of two or more notifiers are started with the same timing, the user is able to easily recognize that these operations are associated with each other.

In the case in which two or more notifiers operate intermittently, the operation of one notifier may be turned on and off in synchronization with the turning on and off of the operation of another notifier. For example, in the case in which the lamp 81 is turned on and off such that an on-state period of 0.5 seconds and an off-state period of 1.0 second are alternately repeated, the sound component 82 may also be turned on and off such that an on-state period of 0.5 seconds and an off-state period of 1.0 second are alternately repeated, so as to synchronize with the lamp 81. Two notifiers may have opposite on/off operations. For example, in the case in which the lamp 81 is turned on and off such that an on-state period of 0.5 seconds and an off-state period of 1.0 second are alternately repeated, the sound component 82 may also be turned on and off such that an off-state period of 0.5 seconds and an on-state period of 1.0 second are alternately repeated, so as to synchronize with the lamp 81. By synchronizing the operations of two or more notifiers with each other, the user is able to easily recognize that these operations are associated with each other.

In the case in which notification by a combination of two or more notifiers is ended after a predetermined period of time has passed since the start of the notification, the process of FIG. 4 may be repeatedly executed at regular intervals.

Next, a process of changing the ways of notification, depending on the remaining battery charge, when the remaining battery charge is lower than or equal to the predetermined value will be described.

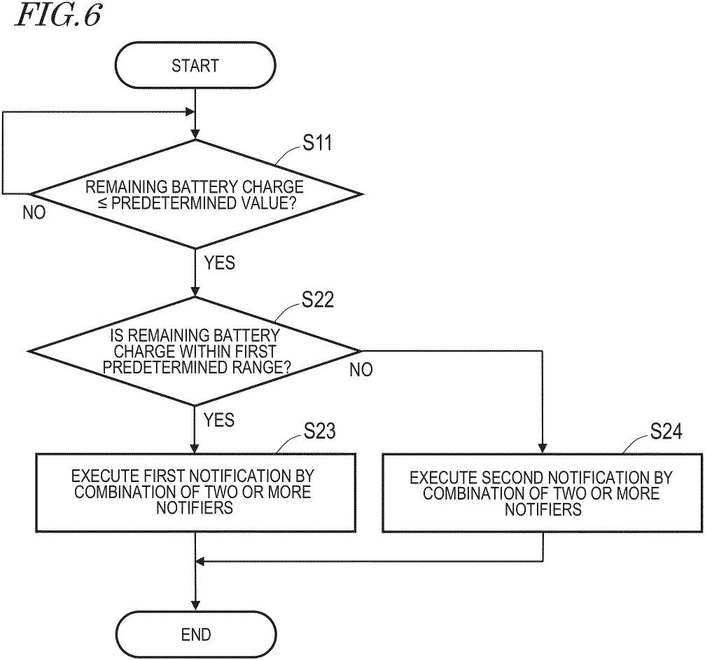

FIG. 6 is a flowchart illustrating a process of changing the ways of notification depending on the remaining battery charge. An operation in step S11 of FIG. 6 is the same as that in step S11 described with reference to FIG. 4.

When the remaining battery charge is lower than or equal to the predetermined value, the processor 51 determines whether or not the remaining battery charge is within a first predetermined range (step S22). The first predetermined range is any appropriate value range, and is, for example, but not limited to, at most 30%. In a preferred embodiment of the present invention, as an example, the first predetermined range is higher than 10% and lower than or equal to 20%.

When the remaining battery charge is within the first predetermined range, the processor 51 executes a first notification in which the operations of two or more of the notifiers, i.e., the display panel 80, the lamp 81, and the sound component 82, are combined together (step S23). The first notification is, for example, that which has been described above with reference to FIG. 5. The processor 51 decreases the number of on-state segments 85a of the indicator 85 by one, and causes the lamp 81 to emit light and causes the sound component 82 to produce sound.

When the remaining battery charge is not within the first predetermined range, the processor 51 executes a second notification in which the operations of two or more of the notifiers, i.e., the display panel 80, the lamp 81, and the sound component 82, are combined together (step S24).

When the remaining battery charge is not within the first predetermined range, the remaining battery charge is within a second predetermined range that is lower than the first predetermined range. In the case in which the first predetermined range is higher than 10% and lower than or equal to 20%, the second predetermined range is, for example, but not limited to, higher than or equal to 0% and lower than or equal to 10%.

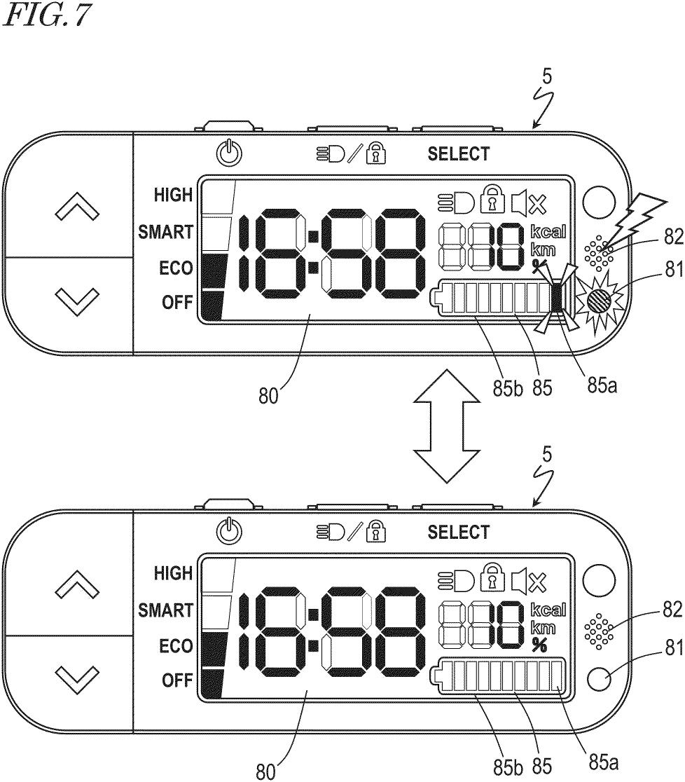

The second notification includes a notification operation that is different from that of the first notification. FIG. 7 is a diagram illustrating an example of an operation for the second notification.

In the notification operation of FIG. 7, the display of a segment(s) 85a of the indicator 85, the light emitted by the lamp 81, and the sound produced by the sound component 82 are intermittently performed. For example, a segment(s) 85a is caused to blink, and the lamp 81 is caused to blink in synchronization with the blink of the segment(s) 85a, and the sound component 82 is caused to produce sound intermittently.

Thus, in a preferred embodiment of the present invention, notification operations are performed that differ between when the remaining battery charge is within the first predetermined range and when the remaining battery charge is within the second predetermined range. By changing the notification operations, depending on the remaining battery charge, the user is able to easily recognize how low the remaining battery charge is.

The interval of blinking and the interval of sound produced described with reference to FIG. 7 may be changed according to a decrease in the remaining battery charge. For example, these intervals may be decreased with a decrease in the remaining battery charge. By decreasing the intervals to make notification more noticeable, the user is prompted to recharge the battery 33.

Notification operations can be distinguished from each other, depending on the remaining battery charge, in any appropriate manner. For example, when the remaining battery charge is within the first predetermined range, notification to the user may be performed by the display panel 80 and a combination of one of the lamp 81 and the sound component 82, and when the remaining battery charge is within the second predetermined range, notification to the user may be performed by the display panel 80 and a combination of the other of the lamp 81 and the sound component 82. For example, when the remaining battery charge is within the first predetermined range, notification may be performed by a combination of the lamp 81 and the display panel 80, and when the remaining battery charge is within the second predetermined range, notification may be performed by a combination of the sound component 82 and the display panel 80.

For example, when the remaining battery charge is within the first predetermined range, notification to the user may be performed by the display panel 80 and a combination of one of the lamp 81 and the sound component 82, and when the remaining battery charge is within the second predetermined range, notification may be performed by a combination of the lamp 81, the sound component 82, and the display panel 80. By increasing the number of elements used for notification according to a decrease in the remaining battery charge, the user is able to easily recognize how low the remaining battery charge is.

The amount of light emitted by the lamp 81 may be different between when the remaining battery charge is within the first predetermined range and when the remaining battery charge is within second predetermined range. The amount of sound produced by the sound component 82 may be different between when the remaining battery charge is within the first predetermined range and when the remaining battery charge is within second predetermined range. By increasing the amount of light of the lamp 81 and/or the amount of sound of the sound component 82 according to a decrease in the remaining battery charge, the user is prompted to recharge the battery 33. Alternatively, the color of light emitted by the lamp 81 may be different between when the remaining battery charge is within the first predetermined range and when the remaining battery charge is within second predetermined range. Alternatively, the type of sound produced by the sound component 82 may be different between when the remaining battery charge is within the first predetermined range and when the remaining battery charge is within second predetermined range.

When the remaining battery charge is 0%, the display panel 80 may be operated such that a frame 85b (FIG. 7) of the indicator 85 is caused to blink at short intervals. This prompts the user to recharge the battery 33.

Next, a notification process that is performed when the power supply of the electric power assisted bicycle 1 is turned off will be described.

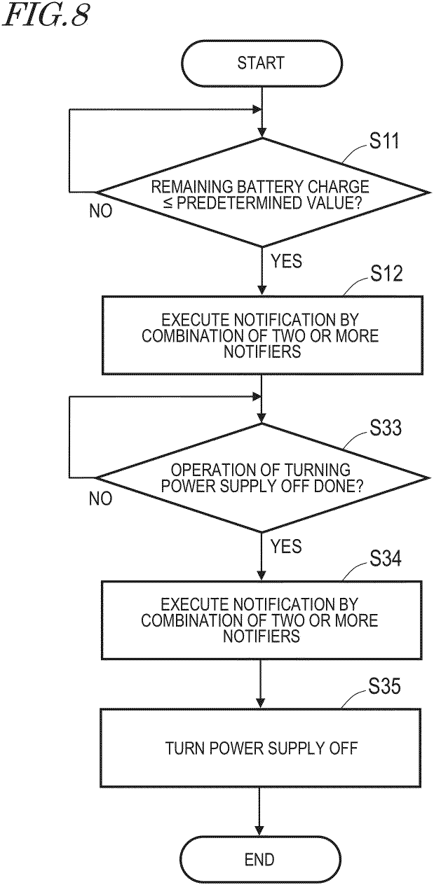

FIG. 8 is a flowchart illustrating a notification process that is performed when the power supply of the electric power assisted bicycle 1 is turned off. Operations in steps S11 and S12 of FIG. 8 are the same as those in steps S11 and S12 described with reference to FIG. 4.

When the remaining battery charge is lower than or equal to the predetermined value, and if the user performs an operation to turn the power supply off by, for example, pressing down the power supply switch 61, the processor 51 notifies the user that the remaining battery charge is low by a combination of two or more notifiers (steps S33 and S34). After notification is performed for a predetermined period of time, the power supply is turned off (step S35). If notification is performed when it is time to turn off the power supply of the electric power assisted bicycle 1 (e.g., when the user returns home), the user is prevented from forgetting to recharge the battery 33.

The operation board 5 may be set such that the sound component 82 is prohibited to produce sound. For example, when the user presses and holds the headlight switch 62 and the select switch 63 simultaneously (FIG. 2), the sound component 82 is prohibited to produce sound. Some users do not prefer the production of sound. In such a case, if the sound component 82 is prohibited to produce sound, the user is able to use the electric power assisted bicycle 1 more comfortably.

In a preferred embodiment of the present invention, even if the sound component 82 is prohibited to produce sound, and when the remaining battery charge is lower than or equal to the predetermined value, and the user performs an operation to turn the power supply off, the sound component 82 is caused to produce sound. Thus, when it is time to turn the power supply off, notification by sound is performed irrespective of whether the sound production is prohibited. Therefore, the user is prevented from forgetting to recharge the battery 33.

Next, a notification process that is performed when the user locks the electric power assisted bicycle 1 will be described.

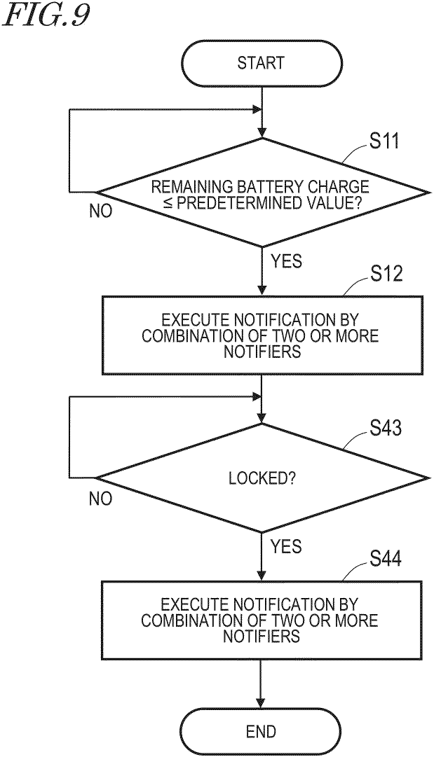

FIG. 9 is a flowchart illustrating a notification process that is performed when the user locks the electric power assisted bicycle 1. Operations in steps S11 and S12 of FIG. 9 are the same as those in steps S11 and S12 described with reference to FIG. 4.

In a preferred embodiment of the present invention, a lock sensor 27 (FIG. 3) is provided for the lock 26 (FIG. 1) of the electric power assisted bicycle 1. The lock sensor 27 has any appropriate configuration to detect a locked state and an unlocked state of the lock 26. For example, the lock sensor 27 may include a magnetic sensor and a magnet, and may detect the locked state and the unlocked state of the lock 26 based on the positional relationship between the magnetic sensor and the magnet, which is different between the locked state and the unlocked state. The lock sensor 27 may include a switching element that switches between electrical connection and disconnection, depending on whether the lock 26 is in the locked state or the unlocked state. For example, the processor 51 is able to detect the locked and unlocked states of the lock 26 based on an output signal of the lock sensor 27.

When the remaining battery charge is lower than or equal to the predetermined value, and if the lock 26 is changed from the unlocked state to the locked state, i.e., the lock 26 is closed, the processor 51 notifies the user that the remaining battery charge is low by a combination of two or more notifiers (steps S43 and S44). If notification is performed when it is time to lock the electric power assisted bicycle 1 (e.g., when the user returns home), the user is prevented from forgetting to recharge the battery 33.

The electric power assisted bicycle 1 may be locked after an operation to turn the power supply off is performed. Therefore, in a preferred embodiment of the present invention, the processor 51 continues to operate in the background for a predetermined period of time even after an operation to turn the power supply off is performed. Notification may be performed when the user locks the electric power assisted bicycle 1 during that period of time.

Next, a notification process that is performed when the electric power assisted bicycle 1 is at rest will be described.

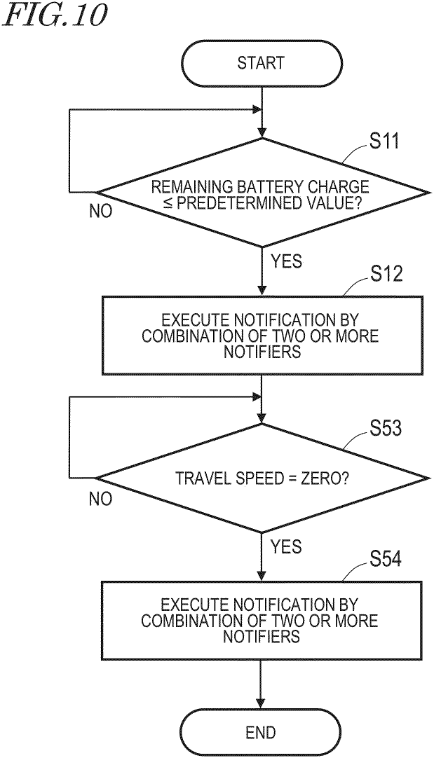

FIG. 10 is a flowchart illustrating a notification process that is performed when the electric power assisted bicycle 1 is at rest. Operations in steps S11 and S12 of FIG. 10 are the same as those in steps S11 and S12 described with reference to FIG. 4.

The speed sensor 25 (FIGS. 1 and 3) detects the angle of rotation of the rear wheel 7, and outputs a signal corresponding to the angle of rotation to the MCU 40, for example. For example, the speed sensor 25 detects the rotation of the rear wheel 7 at predetermined angular intervals, and outputs a signal. The MCU 40 calculates the rotational speed of the rear wheel 7 and the travel speed of the electric power assisted bicycle 1 from the output signal of the speed sensor 25.

The MCU 40 outputs, to the operation board 5, speed information indicating the travel speed of the electric power assisted bicycle 1. The processor 51 causes the display panel 80 to display the travel speed based on the speed information. The processor 51 determines, based on the speed information, whether the electric power assisted bicycle 1 is traveling or at rest.

When the remaining battery charge is lower than or equal to the predetermined value, and if the travel speed is zero, i.e., the electric power assisted bicycle 1 is at rest, the processor 51 causes two or more notifiers to notify the user that the remaining battery charge is low by a combination of the operations of the two or more notifiers (steps S53 and S54). If notification is performed when the electric power assisted bicycle 1 is at rest, the user is able to easily notice the notification.

In the case in which notification is not performed when the electric power assisted bicycle 1 is traveling, and is performed when the electric power assisted bicycle 1 is at rest, step S12 may be omitted.

When the user performs an operation to turn on the power supply of the electric power assisted bicycle 1, and if the remaining battery charge is lower than or equal to the predetermined value, the processor 51 may notify the user that the remaining battery charge is low by a combination of two or more notifiers. For example, when the power supply is turned on, the process of FIG. 4 may be executed to perform a notification. Alternatively, for example, the processor 51 may store the information that the remaining battery charge is lower than or equal to the predetermined value, and may perform the notification when the power supply is turned on. If the notification is performed when the power supply is turned on, the user is prompted to travel using reduced power.

In the above preferred embodiments, a two-wheel electric power assisted bicycle has been illustrated as the electric power assisted vehicle 1. The present invention is not limited to this. For example, the electric power assisted vehicle 1 may be an electric power assisted bicycle with three or more wheels.

In the above preferred embodiments, the drive wheel to which the rider’s pedaling force and the assistance power generated by the electric motor are transmitted is the rear wheel. The present invention is not limited to this. The human power and assistance power may be transmitted to the front wheel, or both of the front wheel and the rear wheel, depending on the configuration of the electric power assisted bicycle.

In the above preferred embodiments, the notification system that notifies the user that the remaining battery charge is low is the operation board 5 provided on the handlebar 4. The present invention is not limited to this. The notification system that notifies the user that the remaining battery charge is low may be provided on, for example, the battery 33 or the body frame 2.

The display panel 80, the lamp 81, and the sound component 82 may not be placed together at a single site. For example, the display panel 80, the lamp 81, and the sound component 82 may be distributed over the electric power assisted vehicle 1.

For example, the lamp 81 may be provided on the operation board 5, and the sound component 82 may be provided on the battery 33. Alternatively, in the case in which a user terminal device such as a smartphone, tablet computer, or bicycle computer is attached to the electric power assisted vehicle 1, such a user terminal device may function as a notifier. For example, the lamp 81 may be provided on the operation board 5, and sound may be produced by the smartphone. In that case, the user terminal device may communicate with the operation board 5 and the drive unit 30 through a wired or wireless connection.

In the above preferred embodiments, the electric power assisted vehicle 1 is an electric power assisted bicycle. The present invention is not limited to this. For example, the electric power assisted vehicle 1 may be an electric power assistance wheelchair.

In the above preferred embodiments, the lamp 81 emits light and the sound component 82 produces sound in order to notify the user that the remaining battery charge is low. The lamp 81 may emit light and the sound component 82 may produce sound during other operations. For example, when the user presses down the assistance power setting switches 64 and 65 to change the assist modes, the lamp 81 may emit light and the sound component 82 may produce sound. In that case, the way of emitting light and the way of producing sound may be changed depending on whether the assist mode is changed to a higher one or a lower one.

In addition, when the user presses down the power supply switch 61 to turn the power supply on or off, the lamp 81 may emit light and the sound component 82 may produce sound. In that case, the way of emitting light and the way of producing sound may be changed depending on whether the power supply is turned on or off. When the power supply is turned off by an automatic power-off function, the lamp 81 may emit light and the sound component 82 may produce sound.

If, when a trouble such as an increase in the temperature of the battery 33 or the MCU 40 occurs in the system, the power of the electric motor 32 is intentionally reduced, the lamp 81 may emit light and the sound component 82 may produce sound. If, when the remaining charge of the battery 33 is low, the power of the electric motor 32 is intentionally reduced, the lamp 81 may emit light and the sound component 82 may produce sound.

When the travel speed exceeds a predetermined value, when an anomaly occurs in the vehicle, or when it is time for maintenance of the vehicle, the lamp 81 may emit light and the sound component 82 may produce sound.

In a preferred embodiment of the present invention, as illustrated in FIG. 2, the shape of the power supply switch 61 is different from that of the headlight switch 62 and the select switch 63. This enables the user to easily recognize the position of the power supply switch 61, which is more frequently used, by the sense of touch even when these switches are disposed at positions that are difficult for the user to see.

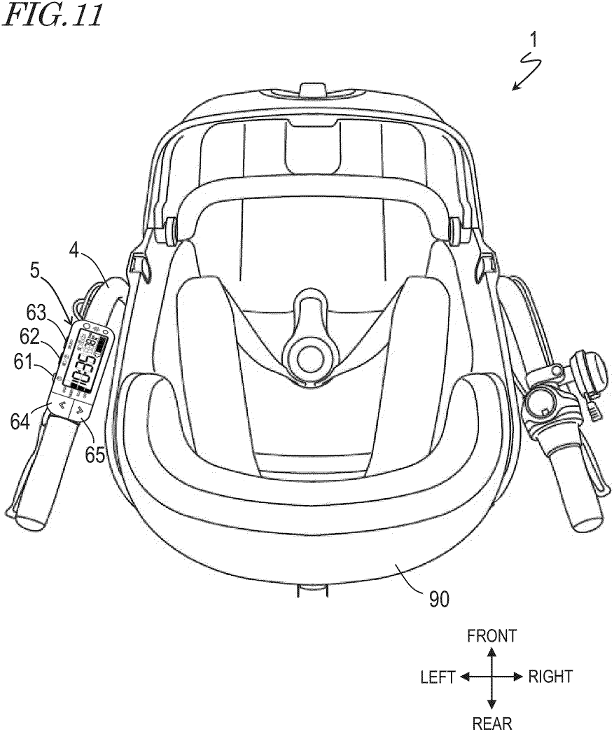

For example, the operation board 5 may be provided on the handlebar 4 with the switches 61, 62, and 63 facing outward from the vehicle. FIG. 11 is a diagram illustrating a front portion of the electric power assisted bicycle 1 at which a child bicycle seat 90, on which a child can sit, is provided on the handlebar 4. Because the switches 61, 62, and 63 of the operation board 5 face outward from the vehicle, a space for operating the switches 61, 62, and 63 with a finger is provided even when the child bicycle seat 90 is provided on the handlebar 4. Meanwhile, because the switches 61, 62, and 63 face outward from the vehicle, these switches may be difficult for the user to see. Even in such a case, because the shape of the power supply switch 61 is different from that of the other switches, the user is able to easily recognize the position of the power supply switch 61 by the sense of touch.

The color of the power supply switch 61 may be different from that of the headlight switch 62 and the select switch 63. This enables the user to easily visually recognize the position of the power supply switch 61.

In a preferred embodiment of the present invention, as illustrated in FIG. 2, the size of the assistance power setting switch 64 is greater than that of the assistance power setting switch 65. It may be desirable to quickly increase the assistance power of the electric motor 32, for example, when the vehicle comes to a steep uphill slope during traveling. Even in such a case, because the assistance power setting switch 64 has a greater size, the user is able to easily operate the assistance power setting switch 64.

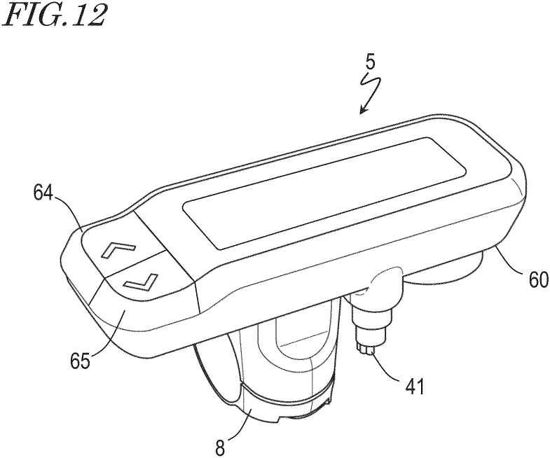

The assistance power setting switches 64 and 65 may further extend on a side wall of the housing 60. FIG. 12 is a perspective view of the operation board 5. Because, as illustrated in FIG. 12, the assistance power setting switches 64 and 65 further extend on a side wall of the housing 60, the assistance power setting switches 64 and 65 are able to be operated by touching a side surface thereof with a finger, resulting in an improvement in operability.

The surfaces of the plurality of switches of the operation board 5 may have different roughnesses. This enables the user to distinguish the switches from each other with the sense of touch without visual recognition.

In the foregoing, illustrative preferred embodiments of the present invention have been described.

A notification system 5 for an electric power assisted vehicle 1 according to a preferred embodiment of the present invention includes two or more notifiers to notify a user that the remaining charge of a battery 33 that supplies power to an electric motor 32 is low, and a control device 50 to control operations of the two or more notifiers. The two or more notifiers include two or more of a display panel 80 to display the remaining battery charge, a lamp 81 to emit light, and a sound component 82 to produce sound. The control device 50 compares the remaining battery charge with a predetermined value. When the remaining battery charge is lower than or equal to the predetermined value, the control device 50 notifies the user that the remaining battery charge is low by a combination of the operations of the two or more notifiers.

The display on the display panel 80 alone may not be enough for the user to actually become aware of the notification. The use of a single notifier, i.e., light or sound alone, may not be enough for the user to recognize what kind of notification is provided. In a preferred embodiment of the present invention, a combination of the operations of the two or more notifiers enables the user to easily and reliably become aware of the notification, and easily recognize that the remaining battery charge is low.

In a preferred embodiment of the present invention, the two or more notifiers may include the display panel 80. When the remaining battery charge is higher than the predetermined value, the control device 50 causes the display panel 80 to display the remaining battery charge, and may cause the other ones, the notifiers 81 and 82, of the two or more notifiers not to operate.

The user is able to recognize the remaining battery charge by seeing the display panel 80.

In a preferred embodiment of the present invention, the two or more notifiers may include the display panel 80 and the lamp 81. When the remaining battery charge is lower than or equal to the predetermined value, the control device 50 may cause the display panel 80 and the lamp 81 to notify the user that the remaining battery charge is low by a combination of a remaining battery charge display on the display panel 80 and light emitted by the lamp 81.

The combination of the display on the display panel 80 and the light emitted by the lamp 81 enables the user to easily notice the notification, and easily recognize that the notification is about a low remaining battery charge.

In a preferred embodiment of the present invention, the two or more notifiers may include the display panel 80 and the sound component 82. When the remaining battery charge is lower than or equal to the predetermined value, the control device 50 may cause the display panel 80 and the sound component 82 to notify the user that the remaining battery charge is low by a combination of a remaining battery charge display on the display panel 80 and sound produced by the sound component 82.

The combination of the display on the display panel 80 and the sound produced by the sound component 82 enables the user to easily notice the notification, and easily recognize that the notification is about a low remaining battery charge.

In a preferred embodiment of the present invention, the two or more notifiers may include the display panel 80, the lamp 81, and the sound component 82. When the remaining battery charge is lower than or equal to the predetermined value, the control device 50 may cause the display panel 80, the lamp 81, and the sound component 82 to notify the user that the remaining battery charge is low by a combination of a remaining battery charge display on the display panel 80, light emitted by the lamp 81, and sound produced by the sound component 82.

The combination of the display on the display panel 80, the light emitted by the lamp 81, and the sound produced by the sound component 82 enables the user to easily notice the notification, and easily recognize that the notification is about a low remaining battery charge.

In a preferred embodiment of the present invention, when the notification to the user is performed by a combination of the operations of the two or more notifiers, the control device 50 may synchronize the operations of the two or more notifiers with each other.

The synchronization of the operations of the two or more notifiers enables the user to easily recognize that the operations of the two or more notifiers are associated with each other.

In a preferred embodiment of the present invention, the control device 50 may provide different notification operations by different combinations of the operations of the two or more notifiers, the notification operations differing between when the remaining battery charge is within a first predetermined range and when the remaining battery charge is within a second predetermined range that is lower than the first predetermined range.

The different notification operations depending on the remaining battery charge enables the user to easily recognize how low the remaining battery charge is.

In a preferred embodiment of the present invention, the two or more notifiers may include the display panel 80, the lamp 81, and the sound component 82. When the remaining battery charge is within the first predetermined range, the control device 50 may notify the user that the remaining battery charge is within the first predetermined range by a remaining battery charge display on the display panel 80 and a combination of one of light emitted by the lamp 81 and sound produced by the sound component 82. When the remaining battery charge is within the second predetermined range, the control device 50 may notify the user that the remaining battery charge is within the second predetermined range by the remaining battery charge display on the display panel 80 and a combination of the other of the light emitted by the lamp 81 and the sound produced by the sound component 82.

By using different notifiers, depending on the amount of a decrease in the remaining battery charge, the user is able to more easily recognize the amount of a decrease in the remaining battery charge.

In a preferred embodiment of the present invention, the two or more notifiers may include the display panel 80, the lamp 81, and the sound component 82. When the remaining battery charge is within the first predetermined range, the control device 50 may notify the user that the remaining battery charge is within the first predetermined range by a remaining battery charge display on the display panel 80 and a combination of one of light emitted by the lamp 81 and sound produced by the sound component 82. When the remaining battery charge is within the second predetermined range, the control device 50 may notify the user that the remaining battery charge is within the second predetermined range by a combination of the light emitted by the lamp 81, the sound produced by the sound component 82, and the remaining battery charge display on the display panel 80.

By increasing the number of notifiers that actually perform the notification with a decrease in the remaining battery charge, the user is able to more easily recognize the amount of a decrease in the remaining battery charge.

In a preferred embodiment of the present invention, when the remaining battery charge is lower than or equal to the predetermined value, and if the user performs an operation to turn off a power supply of the electric power assisted vehicle 1, the control device 50 may cause the two or more notifiers to notify the user that the remaining battery charge is low by a combination of the operations of the two or more notifiers.

Thus, when it is time to turn off the power supply of the electric power assisted vehicle 1 (e.g., when the user returns home), the user is notified, and therefore, is prevented from forgetting to recharge the battery 33.

In a preferred embodiment of the present invention, the two or more notifiers may include the sound component 82, and the notification system 5 may further include a user interface 62, 63 to receive the user’s operation of prohibiting the sound component 82 to produce sound. Even if the sound component 82 is prohibited to produce sound, and when the remaining battery charge is lower than or equal to the predetermined value, and the user performs an operation to turn the power supply off, the sound component 82 may be caused to produce sound.

Thus, when it is time to turn the power supply off, the notification by sound is performed irrespective of whether the sound production is prohibited. Therefore, the user is prevented from forgetting to recharge the battery 33.

In a preferred embodiment of the present invention, when the remaining battery charge is lower than or equal to the predetermined value, and if the user performs an operation to lock the electric power assisted vehicle 1, the control device 50 may cause the two or more notifiers to notify the user that the remaining battery charge is low by a combination of the operations of the two or more notifiers.

Thus, when it is time to lock the electric power assisted vehicle 1 (e.g., when the user returns home), the user is notified, and therefore, is prevented from forgetting to recharge the battery 33.

In a preferred embodiment of the present invention, when the remaining battery charge is lower than or equal to the predetermined value, and if the electric power assisted vehicle 1 is at rest, the control device 50 may cause the two or more notifiers to notify the user that the remaining battery charge is low by a combination of the operations of the two or more notifiers.

Thus, when the vehicle is at rest, the user is notified, and therefore, is able to easily notice the notification.

In a preferred embodiment of the present invention, when the user performs an operation to turn on a power supply of the electric power assisted vehicle 1, and if the remaining battery charge is lower than or equal to the predetermined value, the control device 50 may cause the two or more notifiers to notify the user that the remaining battery charge is low by a combination of the operations of the two or more notifiers.

Thus, when the power supply of the electric power assisted vehicle 1 is turned on, the user is notified, and therefore, is prompted to travel using reduced power.

In a preferred embodiment of the present invention, the two or more notifiers may include the display panel 80 and the lamp 81. The lamp 81 may be disposed adjacent to a portion of the display panel 80 in which the remaining battery charge is displayed.

The user, when noticing the light emitted by the lamp 81, is more likely to pay attention to the remaining battery charge display on the display panel 80, and therefore, is able to easily recognize that the remaining battery charge is low.

In a preferred embodiment of the present invention, the display panel 80 may display an indicator 85 to indicate the remaining battery charge.

Thus, the remaining battery charge is displayed by the indicator 85. This enables the user to intuitively recognize the remaining battery charge.

An electric power assisted vehicle 1 according to a preferred embodiment of the present invention includes the above notification system 5.

The electric power assisted vehicle 1 enables the user to easily recognize that the remaining battery charge is low.

The present invention is particularly useful in the field of electric power assisted vehicles.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A notification system for use in an electric power assisted vehicle, the notification system comprising:
two or more notifiers to notify a user that the remaining charge of a battery that supplies power to an electric motor is low; and
a controller configured or programmed to control operations of the two or more notifiers; wherein
the two or more notifiers include two or more of a display panel to display the remaining battery charge, a lamp to emit light, and a sound component to produce sound;
the controller is configured or programmed to compare the remaining battery charge with a predetermined value, and when the remaining battery charge is lower than or equal to the predetermined value, to notify the user that the remaining battery charge is low by a combination of the operations of the two or more notifiers.

2. The notification system according to claim 1, wherein
the two or more notifiers include the display panel; and
when the remaining battery charge is higher than the predetermined value, the controller is configured or programmed to cause the display panel to display the remaining battery charge, and to cause other ones of the two or more notifiers not to operate.

3. The notification system according to claim 1, wherein
the two or more notifiers include the display panel and the lamp; and
when the remaining battery charge is lower than or equal to the predetermined value, the controller is configured or programmed to cause the display panel and the lamp to notify the user that the remaining battery charge is low by a combination of a remaining battery charge display on the display panel and a light emitted by the lamp.

4. The notification system according to claim 1, wherein
the two or more notifiers include the display panel and the sound component; and
when the remaining battery charge is lower than or equal to the predetermined value, the controller is configured or programmed to cause the display panel and the sound component to notify the user that the remaining battery charge is low by a combination of a remaining battery charge display on the display panel and a sound produced by the sound component.

5. The notification system according to claim 1, wherein
the two or more notifiers include the display panel, the lamp, and the sound component; and
when the remaining battery charge is lower than or equal to the predetermined value, the controller is configured or programmed to cause the display panel, the lamp, and the sound component to notify the user that the remaining battery charge is low by a combination of a remaining battery charge display on the display panel, a light emitted by the lamp, and a sound produced by the sound component.

6. The notification system according to claim 1, wherein
when the notification to the user is performed by a combination of the operations of the two or more notifiers, the controller is configured or programmed to synchronize the operations of the two or more notifiers with each other.

7. The notification system according to claim 1, wherein
the controller is configured or programmed to perform different notification operations by different combinations of the operations of the two or more notifiers, the notification operations differing between when the remaining battery charge is within a first predetermined range and when the remaining battery charge is within a second predetermined range that is lower than the first predetermined range.

8. The notification system according to claim 7, wherein
the two or more notifiers include the display panel, the lamp, and the sound component; and
when the remaining battery charge is within the first predetermined range, the controller is configured or programmed to notify the user that the remaining battery charge is within the first predetermined range by a remaining battery charge display on the display panel and a combination of one of light emitted by the lamp and sound produced by the sound component; and
when the remaining battery charge is within the second predetermined range, the controller is configured or programmed to notify the user that the remaining battery charge is within the second predetermined range by the remaining battery charge display on the display panel and a combination of the other one of the light emitted by the lamp and the sound produced by the sound component.

9. The notification system according to claim 7, wherein
the two or more notifiers include the display panel, the lamp, and the sound component; and
when the remaining battery charge is within the first predetermined range, the controller is configured or programmed to notify the user that the remaining battery charge is within the first predetermined range by a remaining battery charge display on the display panel and a combination of one of light emitted by the lamp and sound produced by the sound component; and
when the remaining battery charge is within the second predetermined range, the controller is configured or programmed to notify the user that the remaining battery charge is within the second predetermined range by a combination of the light emitted by the lamp, the sound produced by the sound component, and the remaining battery charge display on the display panel.

10. The notification system according to claim 1, wherein
when the remaining battery charge is lower than or equal to the predetermined value, and if the user performs an operation to turn off a power supply of the electric power assisted vehicle, the controller is configured or programmed to cause the two or more notifiers to notify the user that the remaining battery charge is low by a combination of the operations of the two or more notifiers.

11. The notification system according to claim 10, wherein
the two or more notifiers include the sound component; and
the notification system further includes a user interface to receive an operation by the user to prohibit the sound component to produce sound; and
even if the sound component is prohibited to produce sound, and when the remaining battery charge is lower than or equal to the predetermined value, and the user performs an operation to turn the power supply off, the controller is configured or programmed to cause the sound component to produce sound.

12. The notification system according to claim 1, wherein
when the remaining battery charge is lower than or equal to the predetermined value, and if the user performs an operation to lock the electric power assisted vehicle, the controller is configured or programmed to cause the two or more notifiers to notify the user that the remaining battery charge is low by a combination of the operations of the two or more notifiers.

13. The notification system according to claim 1, wherein
when the remaining battery charge is lower than or equal to the predetermined value, and if the electric power assisted vehicle is at rest, the controller is configured or programmed to cause the two or more notifiers to notify the user that the remaining battery charge is low by a combination of the operations of the two or more notifiers.

14. The notification system according to claim 1, wherein
when the user performs an operation to turn on a power supply of the electric power assisted vehicle, and if the remaining battery charge is lower than or equal to the predetermined value, the controller is configured or programmed to cause the two or more notifiers to notify the user that the remaining battery charge is low by a combination of the operations of the two or more notifiers.

15. The notification system according to claim 1, wherein
the two or more notifiers include the display panel and the lamp; and
the lamp is adjacent to a portion of the display panel in which the remaining battery charge is displayed.

16. The notification system according to claim 1, wherein
the display panel displays an indicator to indicate the remaining battery charge.

17. An electric power assisted vehicle comprising:
the notification system according to claim 1.
